(19) United States
(12) Patent Application Publication
(10) Pub. No.: US 2020/0065534 A1
(43) Pub. Date: Feb. 27, 2020

(54) PRODUCT MANUFACTURING METHOD, PRODUCT, AND NON-TRANSITORY COMPUTER READABLE MEDIUM

(71) Applicant: FUJI XEROX CO., LTD., Tokyo (JP)

(72) Inventors: Eisaku HAYASHI, Kanagawa (JP); Shigeru YAMAMOTO, Kanagawa (JP); Kensuke ITO, Kanagawa (JP); Masahiro IGUSA, Kanagawa (JP)

(73) Assignee: FUJI XEROX CO., LTD., TOKYO (JP)

(21) Appl. No.: 16/544,926

(22) Filed: Aug. 20, 2019

(30) Foreign Application Priority Data
Aug. 27, 2018 (JP) 2018-158262

(51) Int. Cl. G06K 7/10; G06K 7/14; G06K 19/06

(52) U.S. Cl. CPC G06K 7/10722; G06K 19/06028; G06K 7/1413

(57) ABSTRACT

A product manufacturing method includes acquiring a random pattern in one region on a surface of a first member by capturing an image of the first member; acquiring identification information, based on which a second member is individually identifiable, from the second member, the second member being combined with the first member to constitute a product; storing the acquired random pattern and the acquired identification information in association with each other; and forming the product by combining the first member and the second member.

### CROSS-REFERENCE TO RELATED APPLICATIONS

This application is based on and claims priority under 35 USC 119 from Japanese Patent Application No. 2018-158262 filed Aug. 27, 2018.

### BACKGROUND

### (i) Technical Field

The present disclosure relates to product manufacturing methods, products, and non-transitory computer readable media.

### (ii) Related Art

Japanese Unexamined Patent Application Publication No. 2005-010581 discloses an item checking method that involves reading a random pattern, which is a fine non-reproducible feature originally included in an item, from a predetermined observation region on the surface of the item, and preliminarily attaching a protection member to a section that includes the observation region of the random pattern when individual items are to be identified or verified by using this random pattern.

Japanese Patent No. 4538617 discloses an authenticity determination apparatus that preliminarily stores individual information and accidental random-number information in association with each other. The individual information is uniquely given to each machine-readable sheet. The accidental random-number information has no correlation with machine-readable identification information and utilizes randomness occurring during a manufacturing process of the sheet. If the individual information and the accidental random-number information match, the authenticity determination apparatus determines that the sheet is authentic.

### SUMMARY

Aspects of non-limiting embodiments of the present disclosure relate to a product manufacturing method, a product, and a non-transitory computer readable medium in which it is possible to check whether or not a combination of a first member and a second member constituting a product has been changed after shipment of the product.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a product manufacturing method including acquiring a random pattern in one region on a surface of a first member by capturing an image of the first member; acquiring identification information, based on which a second member is individually identifiable, from the second member, the second member being combined with the first member to constitute a product; storing the acquired random pattern and the acquired identification information in association with each other; and forming the product by combining the first member and the second member.

### BRIEF DESCRIPTION OF THE DRAWINGS

Exemplary embodiments of the present disclosure will be described in detail based on the following figures, wherein:

FIG. 1 is a perspective view of a product subject to a determination process in an information processing system according to a first exemplary embodiment of the present disclosure;

FIG. 2 schematically illustrates a manufacturing apparatus for manufacturing the product shown in FIG. 1;

FIG. 3 illustrates how a random pattern is acquired from a seal opener of a packaging film;

FIG. 4 is a flowchart illustrating the operation of the product manufacturing apparatus shown in FIG. 2;

FIG. 5 illustrates an example of contents stored in a random-pattern storage unit;

FIG. 6 illustrates a system configuration of a determination system for determining whether or not the product has been opened;

FIG. 7 illustrates how serial number information based on which a product body is individually identifiable is acquired through a transparent or semitransparent material of the packaging film;

FIG. 8 illustrates a hardware configuration of a determination server according to the first exemplary embodiment of the present disclosure;

FIG. 9 illustrates a functional configuration of the determination server according to the first exemplary embodiment of the present disclosure;

FIG. 10 illustrates a first display example in a case where a determination result obtained in the determination server is displayed in a portable terminal apparatus that has received the determination result from the determination server;

FIG. 11 illustrates a second display example in a case where a determination result obtained in the determination server is displayed in the portable terminal apparatus that has received the determination result from the determination server;

FIG. 12 illustrates a product configured such that the location of a region where a random pattern is acquired from the seal opener and the location where a serial number is acquired are close to each other;

FIG. 13 illustrates a case where a random pattern acquired from a specific region of the product body is used as identification information;

FIG. 14 is a perspective view of a product subject to a determination process in an information processing system according to a second exemplary embodiment of the present disclosure;

FIG. 15 schematically illustrates a manufacturing apparatus for manufacturing the product shown in FIG. 14;

FIG. 16 is a flowchart illustrating the operation of the product manufacturing apparatus shown in FIG. 15;

FIG. 17 illustrates the configuration of the product manufactured by the manufacturing apparatus shown in FIG. 15;

FIG. 18 illustrates a determination apparatus for checking whether or not the product has been opened;

FIG. 19 illustrates a hardware configuration of a portable terminal apparatus functioning as the determination apparatus;

FIG. 20 illustrates a function configuration of the portable terminal apparatus functioning as the determination apparatus; and

FIG. 21 illustrates a sealed document constituted of a document sealed in an envelope.

### DETAILED DESCRIPTION

Next, exemplary embodiments of the present disclosure will be described with reference to the drawings.

### First Exemplary Embodiment

First, an information processing system according to a first exemplary embodiment of the present disclosure will be described.

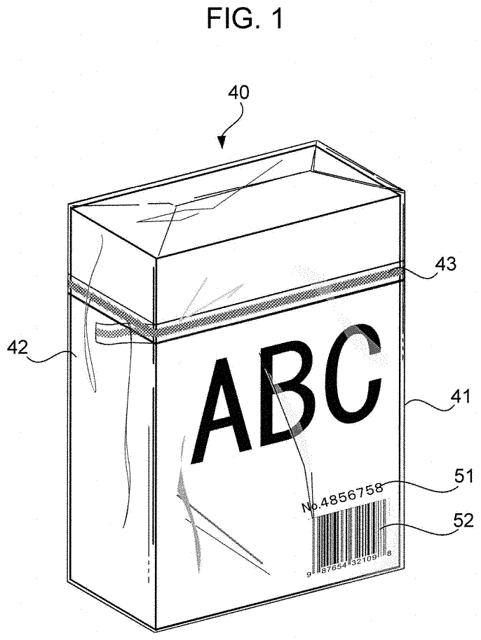

For example, the information processing system according to this exemplary embodiment determines whether or not a product 40, as shown in FIG. 1, has been opened after being shipped from a factory.

The product 40 includes a product body 42 packaged in a transparent packaging film 41. This packaging film 41 is a packaging member for packaging the product body 42. In other words, the product 40 is constituted of a combination of the packaging film 41 (first member) and the product body (second member). A serial number 51 and a bar code (one-dimensional code) 52 as identification information for individual product identification are printed on the product body 42. The packaging film 41 is provided with a seal opener 43. A user who has purchased the product 40 may manually pull on this seal opener 43 to tear the packaging film 41, so that the packaging film 41 may be readily removed from the product body 42. The seal opener (tear tape) 43 is attached to the inner side of the packaging film 41.

Normally, when the purchaser of the product 40 removes the packaging film 41, it is not possible to recover the packaged state again since the packaging film 41 is torn.

However, if an ill-intentioned person replaces the contents of the product body 42 with a counterfeit and wraps the product body 42 with a similar transparent packaging film, it is difficult to determine whether the product 40 has been opened once or has not been opened.

As a countermeasure against such a problem, the information processing system according to this exemplary embodiment may determine whether the products 40 in the market have not been opened after being shipped from the factory or have been repackaged after being opened once.

A determination method performed by the information processing system according to this exemplary embodiment will be described below in detail.

First, a method for manufacturing the product 40 subject to a determination process in the information processing system according to this exemplary embodiment will be described.

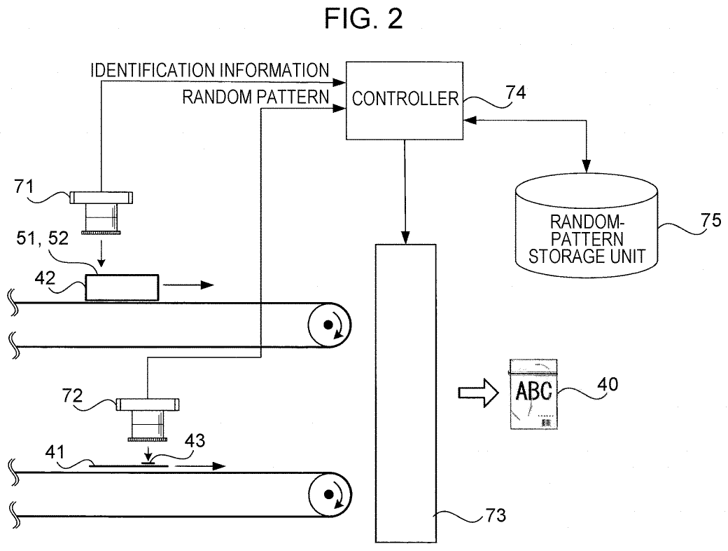

FIG. 2 schematically illustrates a manufacturing apparatus for manufacturing the product 40.

The manufacturing apparatus shown in FIG. 2 includes cameras 71 and 72, a packaging device 73, a controller 74, and a random-pattern storage unit 75.

The camera 71 acquires identification information, based on which the product body 42 is individually identifiable, from the product body 42 that constitutes the product 40 by being combined with the packaging film 41. In detail, the camera 71 captures an image of a predetermined location of the product body 42 so as to acquire information about the serial number (product number) 51, as the identification information for individually identifying the product body 42, indicated on the surface of the product body 42. The expression “indicated on the surface of the product body 42” includes every possible state where the serial number 51 is visually recognizable from the outside by printing the serial number 51 directly onto the surface, bonding a sticker having the serial number 51 printed thereon onto the surface, or stamping the serial number 51 onto the surface of the product body 42.

Although the serial number 51 is used as the identification information in the following description, the bar code 52 may also be used as the identification information. Furthermore, although not shown in FIG. 1, information other than the serial number 51 or the bar code 52, such as a QR code (registered trademark), may alternatively be used as the identification information so long as such information is usable for individual product identification.

The camera 72 captures an image of the seal opener 43 in the packaging film 41 so as to acquire a random pattern in one region on the surface of the packaging film 41.

A random pattern is a characteristic pattern formed of a fine shaded or topographic imprint on the surface of an object and is unique to each object.

For example, various types of objects, such as paper, metal, and plastic, have unique random patterns on the surface thereof, similar to human fingerprints, vein patterns, and iris patterns. Therefore, it is possible to determine whether objects are the same by acquiring an image of a part of a random pattern distributed along the surface of each object, registering the acquired image as reference data, acquiring a random pattern captured again from the same location of the object as verification data, and verifying the verification data against the preregistered reference data.

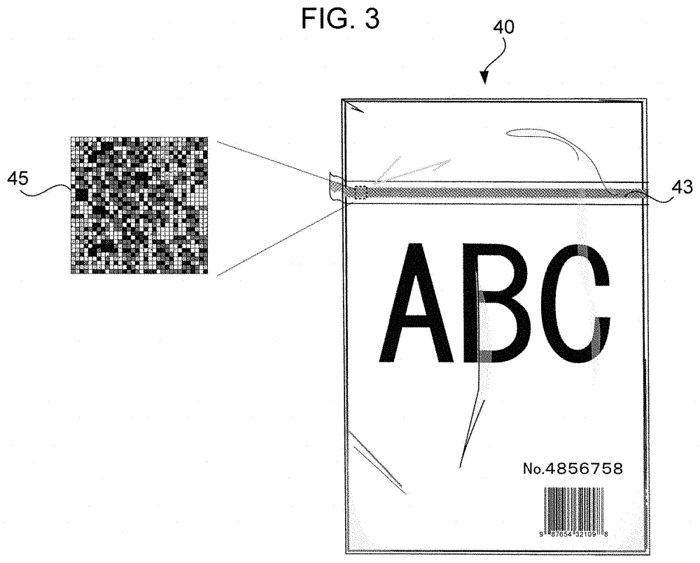

The packaging film 41 is formed of a transparent or semitransparent material so that the packaged product body 42 is visually recognizable, whereas the seal opener 43 has a region that is not transparent or semitransparent but is given an identical color. Therefore, as shown in FIG. 3, by using the camera 72 to capture the colored region of the seal opener 43, a random pattern 45 may be acquired.

Although this exemplary embodiment relates to a case where the seal opener 43 alone is colored and other regions of the packaging film 41 are transparent, if one region of the packaging film 41 is colored instead of being transparent or semitransparent, the random pattern may be acquired from such a region.

As mentioned above, the seal opener 43 is bonded to the inner side of the transparent packaging film 41, that is, the side facing the product body 42. Therefore, the packaging film 41 has a role of protecting the registered random pattern of the seal opener 43 from vibration and impact occurring during transport. When performing verification by acquiring the random pattern from the surface of the seal opener 43, the random pattern on the seal opener 43 provided underneath the packaging film 41 is read through the transparent packaging film 41. After the packaging film 41 is opened, the verification may be performed by directly reading the random pattern on the seal opener 43 instead of reading the random pattern through the packaging film 41.

The random-pattern storage unit 75 stores the random pattern acquired by the camera 72 and the serial number information acquired by the camera 71 in association with each other.

The packaging device 73 packages the product body 42 by using the packaging film 41, so that the product 40 is manufactured. In other words, the packaging device 73 functions as a forming unit that forms the product 40 by combining the product body 42 and the packaging film 41 with each other.

The controller 74 controls the operation of the manufacturing apparatus shown in FIG. 2. Specifically, the controller 74 causes the random-pattern storage unit 75 to store the identification information, such as the serial number, acquired by the camera 71 and the random pattern acquired by the camera 72, and also controls the operation of the packaging device 73.

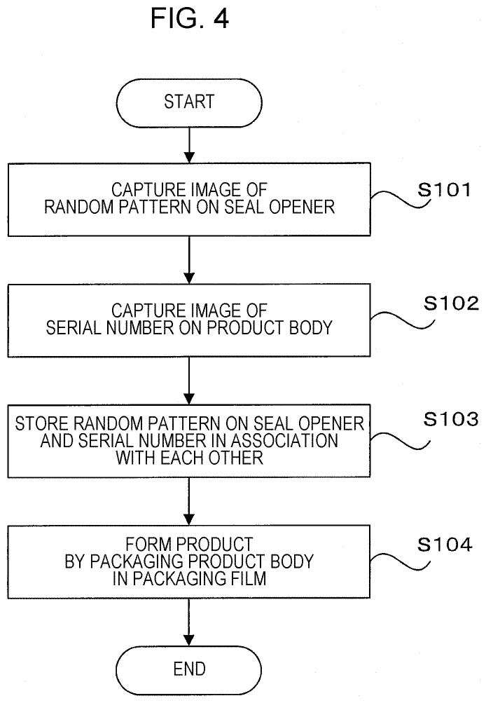

The operation of the product manufacturing apparatus shown in FIG. 2 will now be described with reference to a flowchart in FIG. 4.

In step S101, the controller 74 controls the camera 72 to capture a specific region of the seal opener 43, thereby acquiring the random pattern in one region on the surface of the seal opener 43 provided in the packaging film 41. Then, in step S102, the controller 74 controls the camera 71 to capture a specific region of the product body 42, thereby acquiring, from the product body 42, the information about the serial number 51 serving as the identification information for individually identifying the product body 42. In step S103, the controller 74 associates the acquired random pattern of the seal opener 43 and the acquired serial number 51 with each other, and stores the acquired random pattern and the acquired serial number 51 in the random-pattern storage unit 75.

In step S104, the controller 74 controls the packaging device 73 so that the product body 42 is packaged in the packaging film 41, thereby forming the product 40.

In the above description, the random pattern is acquired from the seal opener 43 of the packaging film 41 and the information about the serial number 51 is acquired from the product body 42 before the product body 42 is packaged in the packaging film 41. Alternatively, since the packaging film 41 is formed of a transparent material, the random pattern may be acquired from the seal opener 43 of the packaging film 41, and the information about the serial number 51 may be acquired from the product body 42 through the packaging film 41 after the product body 42 is packaged in the packaging film 41, that is, upon completion of the product 40.

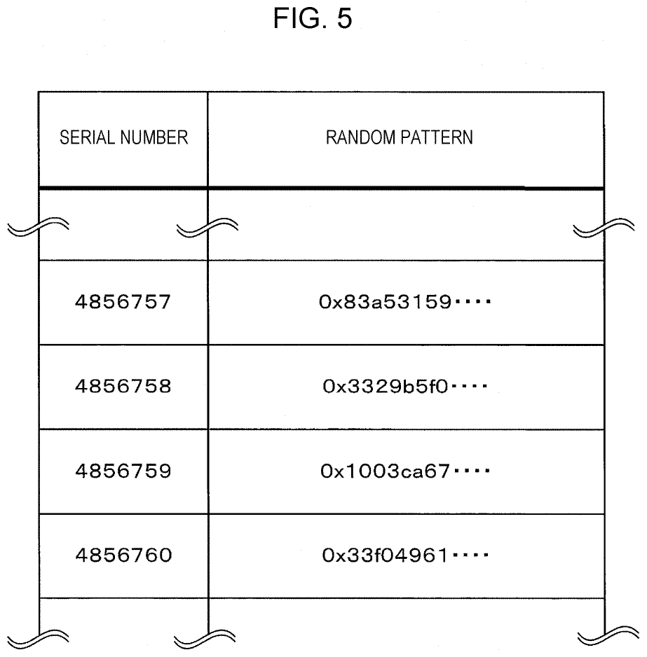

Next, an example of contents stored in the random-pattern storage unit 75 will be described with reference to FIG. 5.

As shown in FIG. 5, the random-pattern storage unit 75 stores the information about the random pattern acquired from the packaging film 41 and the serial number of the product body 42 packaged in the packaging film 41, from which the random pattern is acquired, in association with each other.

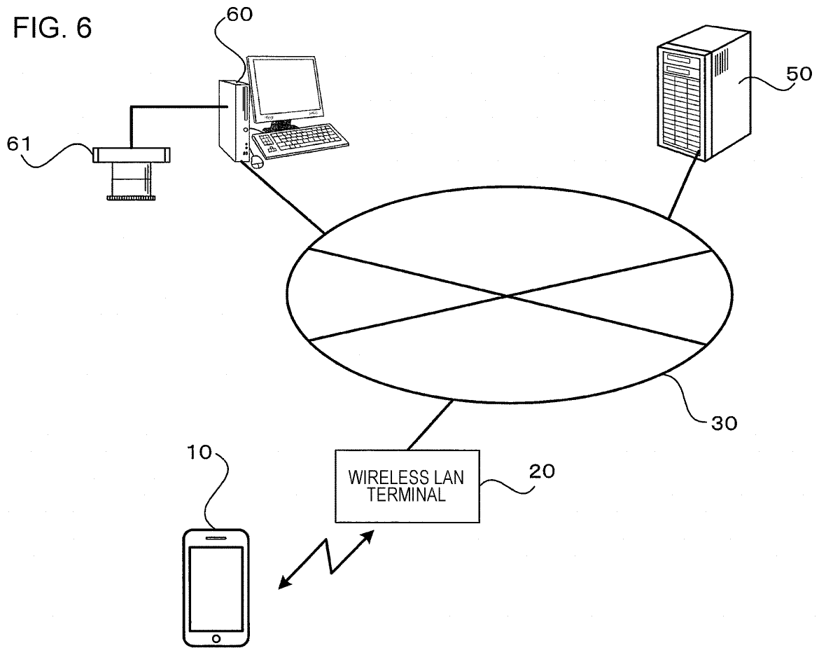

The following description with reference to FIG. 6 relates to a determination system that determines whether the product 40 manufactured by the manufacturing apparatus shown in FIG. 2 has not been opened or has been repackaged after being opened once after the product 40 is collected and shipped in the market.

In the determination system shown in FIG. 6, a determination server 50 serving as a determination apparatus that determines whether the product 40 subject to the determination process has not been opened or has been repackaged, a portable terminal apparatus 10 that makes a request for the determination process to the determination server 50, and a terminal apparatus 60 are connected to one another via a network 30.

The portable terminal apparatus 10, such as a smartphone, performs wireless communication with, for example, a wireless local area network (LAN) terminal 20, so as to make a determination request to the determination server 50 via the network 30 and to receive a determination result from the determination server 50.

The terminal apparatus 60 is connected to a camera 61 and uses the camera 61 to capture an image of the product 40 subject to the determination process. The terminal apparatus 60 makes a determination request to the determination server 50 via the network 30 and receives a determination result from the determination server 50.

The following description relates to a case where it is determined whether or not the product 40 is unopened by using the portable terminal apparatus 10.

When checking whether or not the product 40 has been opened, the portable terminal apparatus 10 or the camera 61 captures an image of the random pattern in a preset region of the seal opener 43 of the product 40 subject to the determination process and the information about the serial number 51 printed on a predetermined location of the product body 42.

Because the packaging film 41 is formed of a transparent material, it is possible to acquire the random pattern of the seal opener 43 and the information about the serial number 51 (bar code 52) in a state where the product 40 is still packaged in the packaging film 41.

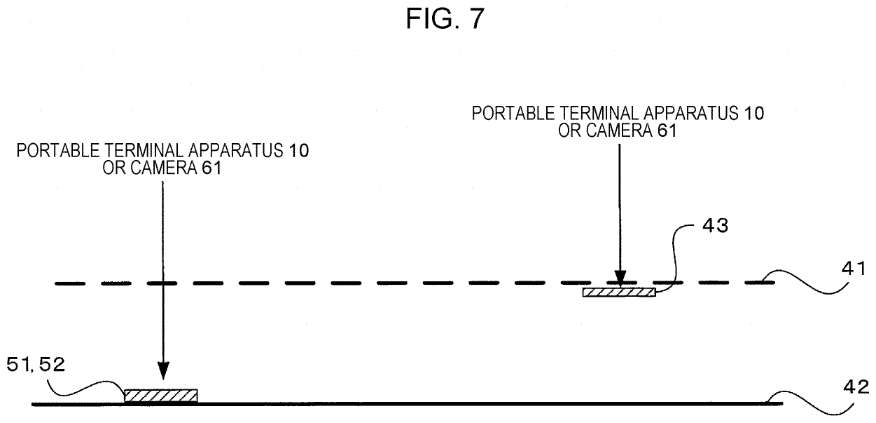

Specifically, as shown in FIG. 7, so long as at least a part of the packaging film 41 serving as a packaging member is formed of a transparent or semitransparent material, the serial number information for individually identifying the product body 42 is acquirable through the transparent or semitransparent material of the packaging film 41.

In this exemplary embodiment, the packaging film 41 is substantially entirely transparent except for the region of the seal opener 43. Alternatively, the determination of whether or not the product 40 has been opened is possible in the packaged state so long as the region corresponding to the printed region of the serial number 51 (bar code 52) is transparent or semitransparent.

Moreover, even if the packaging member used for packaging the product body 42 is not transparent or semitransparent, the determination of whether or not the product 40 has been opened is possible in the packaged state so long as the region corresponding to the printed region of the serial number 51 (bar code 52) is cut out.

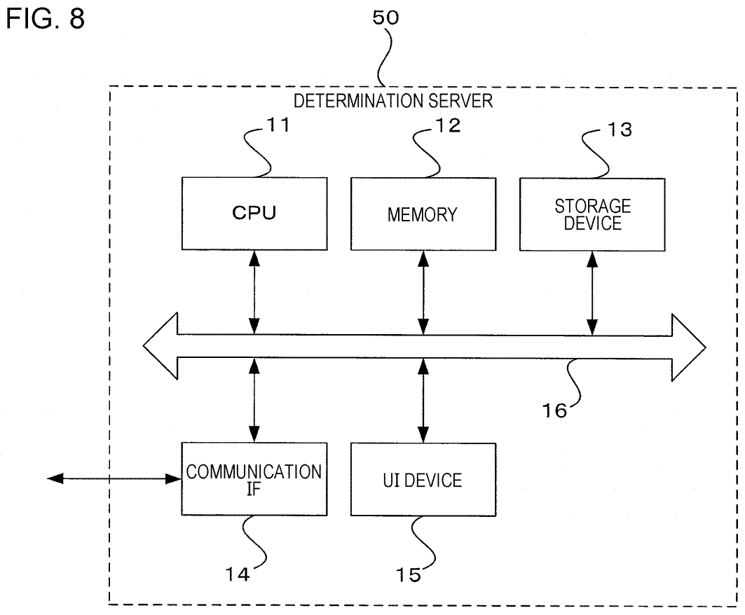

Next, a hardware configuration of the determination server 50 for performing such a determination process will be described with reference to FIG. 8.

As shown in FIG. 8, the determination server 50 includes a central processing unit (CPU) 11, a memory 12, a storage device 13, such as a hard disk drive (HDD), a communication interface (IF) 14 that transmits and receives data to and from an external device via the network 30, and a user interface (UI) device 15 that includes a touchscreen or a liquid crystal display and a keyboard. These components are connected to one another via a control bus 16.

The CPU 11 executes a predetermined process based on a control program stored in the memory 12 or the storage device 13, so as to control the operation of the determination server 50. Although the CPU 11 reads and executes the program stored in the memory 12 or the storage device 13 in this exemplary embodiment, the program may alternatively be stored in a storage medium, such as a CD-ROM, and may be provided to the CPU 11.

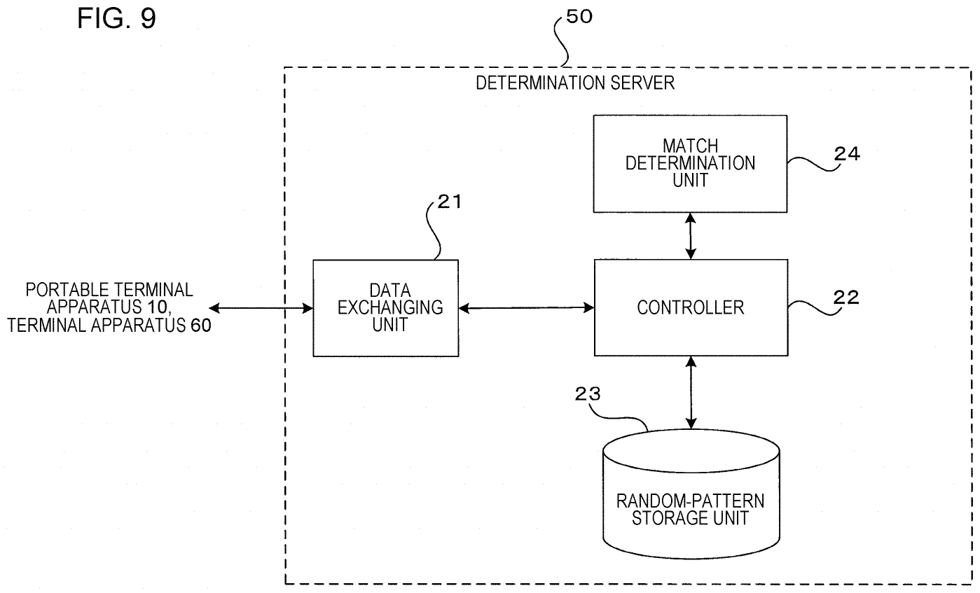

FIG. 9 is a block diagram illustrating a functional configuration of the determination server 50 realized as a result of executing the aforementioned control program.

As shown in FIG. 9, the determination server 50 according to this exemplary embodiment includes a data exchanging unit 21, a controller 22, a random-pattern storage unit 23, and a match determination unit 24.

The random-pattern storage unit 23 has a configuration similar to that of the random-pattern storage unit 75 shown in FIG. 2 and stores the random pattern acquired from the packaging film 41 of the product 40, constituted of a combination of the packaging film 41 and the product body 42, and the identification information, such as the information about the serial number acquired from the product body 42, in association with each other.

The data exchanging unit 21 exchanges data with the portable terminal apparatus 10 or the terminal apparatus 60 so as to receive a determination request from the portable terminal apparatus 10 or the terminal apparatus 60 or to reply to the portable terminal apparatus 10 or the terminal apparatus 60 by transmitting thereto a determination result for the received determination request.

The controller 22 acquires, via the data exchanging unit 21, the random pattern in one region on the surface of the seal opener 43 obtained as a result of capturing an image of the seal opener 43 provided in the packaging film 41 of the product 40 subject to the determination process.

Moreover, the controller 22 acquires the information about the serial number, serving as the identification information for individually identifying the product body 42, from the product body 42 constituting the product 40 subject to the determination process.

Then, the controller 22 reads the random pattern stored in association with the acquired serial number from the random-pattern storage unit 75, and causes the match determination unit 24 to determine whether or not the read random pattern matches the acquired random pattern of the seal opener 43.

The match determination unit 24 determines whether or not the random pattern read from the random-pattern storage unit 75 matches the random pattern acquired from the seal opener 43 at the time of the determination process.

For example, the match determination unit 24 performs the match determination process by calculating a correlation coefficient (coefficient value) by performing a correlation calculation of density values of the pixels in each of the two random patterns.

The random pattern read from the random-pattern storage unit 75 is a random pattern acquired from a predetermined region of the seal opener 43 when the product 40 is manufactured.

Therefore, these two random patterns should match unless the product 40, after being shipped from the factory, has been opened once in the market and then repackaged.

Therefore, if the random patterns compared by the match determination unit 24 match, the controller 22 notifies the portable terminal apparatus 10, which has made the determination request, that the combination of the packaging film 41 and the product body 42 in the product 40 subject to the determination process has not been changed, that is, the product 40 has not been opened after being shipped from the factory.

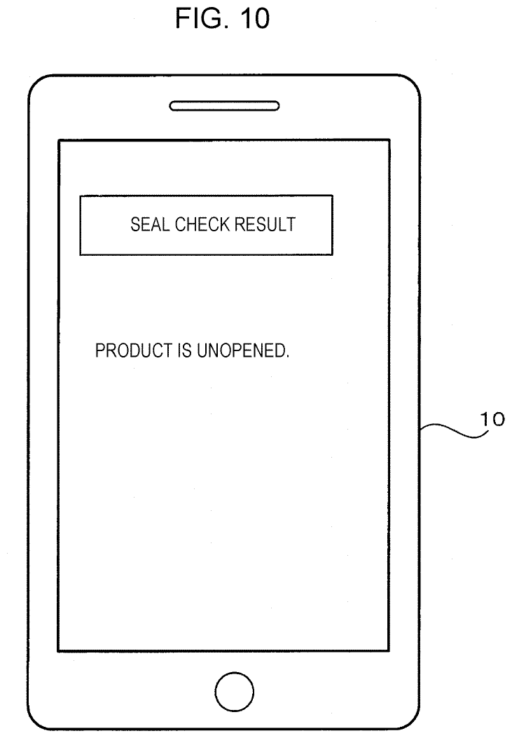

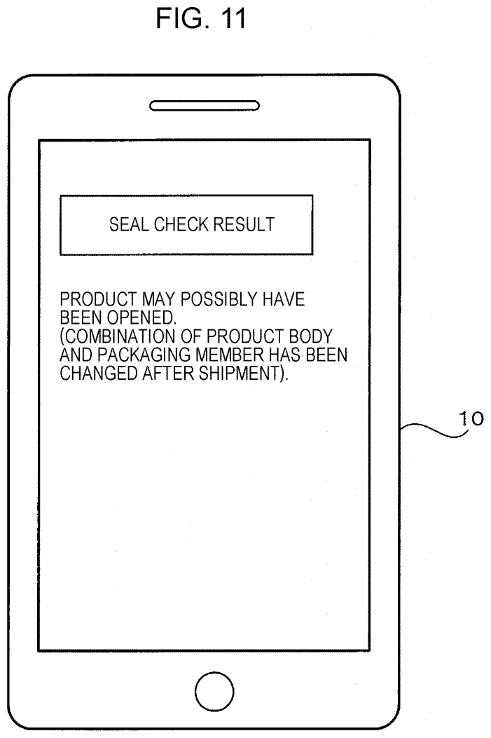

FIGS. 10 and 11 illustrate display examples in a case where a determination result obtained in the determination server 50 is displayed in the portable terminal apparatus 10 that has received the determination result.

FIG. 10 illustrates a case where the two random patterns compared in the determination server 50 match and the product 40 is thus determined that it has not been opened after being shipped from the factory. In this case, for example, a message “product is unopened” is displayed on the display of the portable terminal apparatus 10, as shown in FIG. 10, so that the user is notified of the determination result indicating that the product that has undergone the determination process is unopened.

FIG. 11 illustrates a case where the two random patterns compared in the determination server 50 do not match and the product 40 is thus determined that it has possibly been opened after being shipped from the factory. In this case, for example, a message “product may possibly have been opened” is displayed on the display of the portable terminal apparatus 10, as shown in FIG. 11, so that the user is notified of the determination result indicating that there is a possibility that the product that has undergone the determination process has been opened once.

In the product 40 described above, the location of the region where the random pattern is acquired from the seal opener 43 and the location where the serial number 51 is acquired are distant from each other. Therefore, in order to capture an image of both the random pattern and the serial number 51 in a single image capturing operation, a high-resolution camera is necessary. Otherwise, an image of the random pattern and an image the serial number 51 have to be captured individually in two image capturing operations.

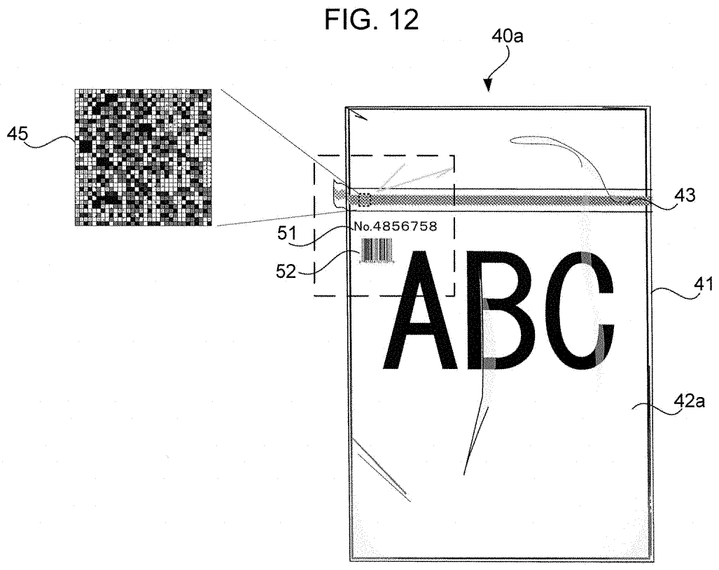

In contrast, if the location of the region where the random pattern is acquired from the seal opener 43 and the location where the serial number 51 is acquired are close to each other, as in a product 40a shown in FIG. 12, the two pieces of information may be acquired simultaneously in a single image capturing process without using a high-resolution camera.

In a product body 42a of the product 40a shown in FIG. 12, the serial number 51 and the bar code 52 are printed directly below the location of the region where the random pattern is acquired from the seal opener 43, such that the serial number 51 and the bar code 52 are included in the imaging range when the random pattern is to be acquired from the seal opener 43.

Furthermore, the above-described exemplary embodiment relates to a case where the information about the serial number 51 is used as the information for individually identifying the product body 42. Alternatively, a random pattern on the surface of the product body 42 may be used as the information for individually identifying the product body 42.

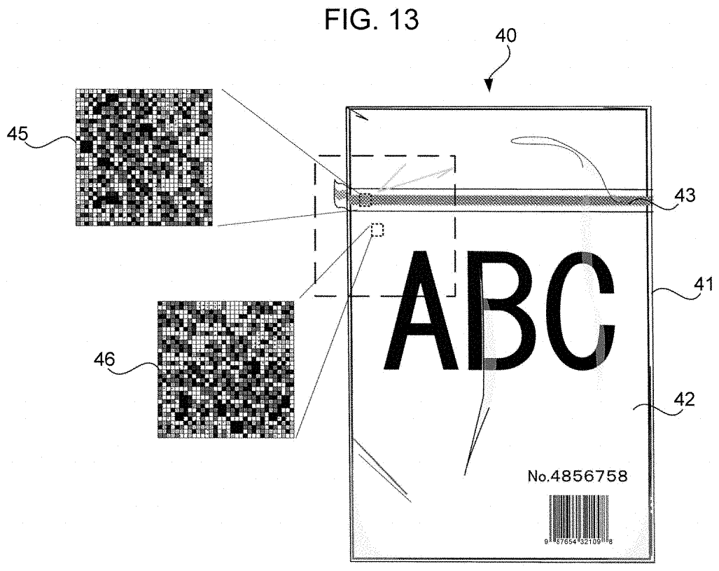

In detail, as shown in FIG. 13, a random pattern 46 may be acquired from a specific region of the product body 42 located adjacent to the location of the region where the random pattern 45 is acquired from the seal opener 43, and the random pattern 45 and the random pattern 46 may be stored in association with each other in the random-pattern storage units 23 and 75.

### Second Exemplary Embodiment

Next, an information processing system according to a second exemplary embodiment of the present disclosure will be described.

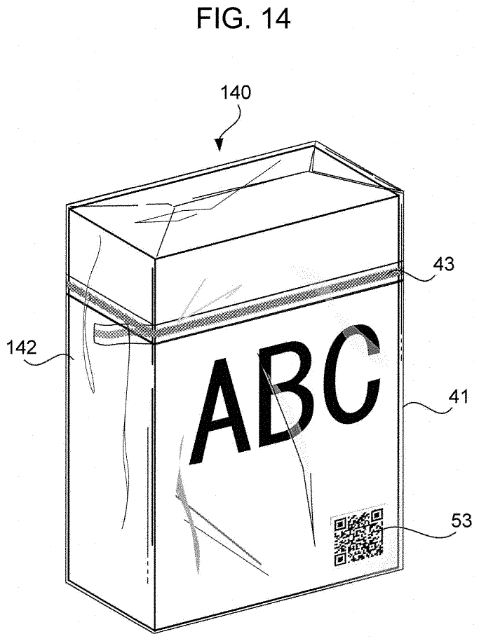

The information processing system according to this exemplary embodiment determines whether or not a product 140, as shown in FIG. 14, instead of the product 40 shown in FIG. 1 has been opened after being shipped from a factory. In this exemplary embodiment, components similar to those used in the first exemplary embodiment described above are given the same reference signs, and descriptions thereof are omitted.

The product 140 includes a product body 142 packaged in the transparent packaging film 41. A two-dimensional code 53, such as a QR code (registered trademark), is printed on the product body 142.

The two-dimensional code 53 is code information about an encoded random pattern in one region on the surface of the seal opener 43 obtained by capturing an image of the seal opener 43 of the packaging film 41.

Specifically, the product 140 used in this exemplary embodiment is constituted of a combination of the packaging film 41, including the seal opener 43 having the random pattern on the surface thereof, and the product body 142 whose surface has printed thereon, as the two-dimensional code 53, the code information about the encoded random pattern obtained by capturing the image of the seal opener 43 of the packaging film 41.

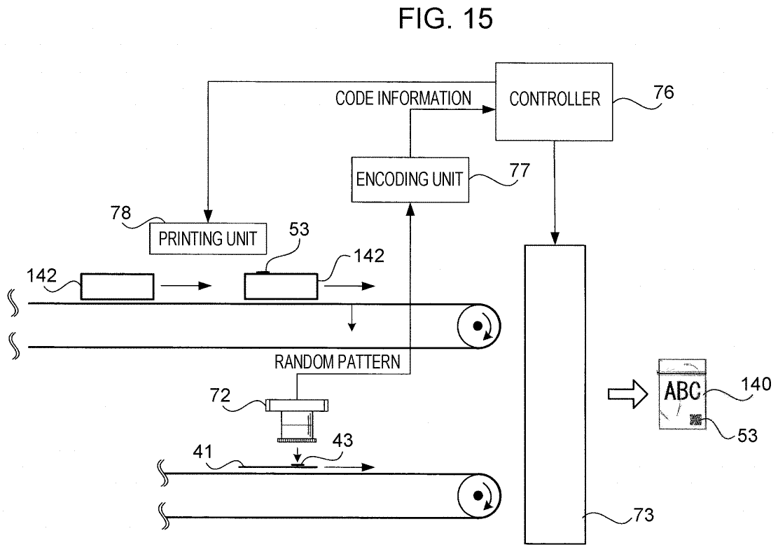

FIG. 15 schematically illustrates a manufacturing apparatus for manufacturing the product 140.

The manufacturing apparatus shown in FIG. 15 includes a camera 72, a packaging device 73, a controller 76, an encoding unit 77, and a printing unit 78.

The camera 72 captures an image of the seal opener 43 in the packaging film 41 so as to acquire a random pattern in one region on the surface of the packaging film 41.

The encoding unit 77 generates code information by encoding the random pattern acquired by the camera 72.

The controller 76 controls the printing unit 78 so as to print the code information generated by the encoding unit 77 as the two-dimensional code 53 onto the surface of the product body 142 constituting the product 140 by being combined with the packaging film 41.

Moreover, the controller 76 controls the packaging device 73 so that the product body 142 is packaged in the packaging film 41, thereby forming the product 140.

The product 140 according to this exemplary embodiment is similar to the product 40 according to the first exemplary embodiment described above in that the packaging film 41 is formed of a transparent material, so that the two-dimensional code 53 printed on the surface of the product body 142 is readable from the product body 42 in a state where the product body 42 is packaged in the packaging film 41.

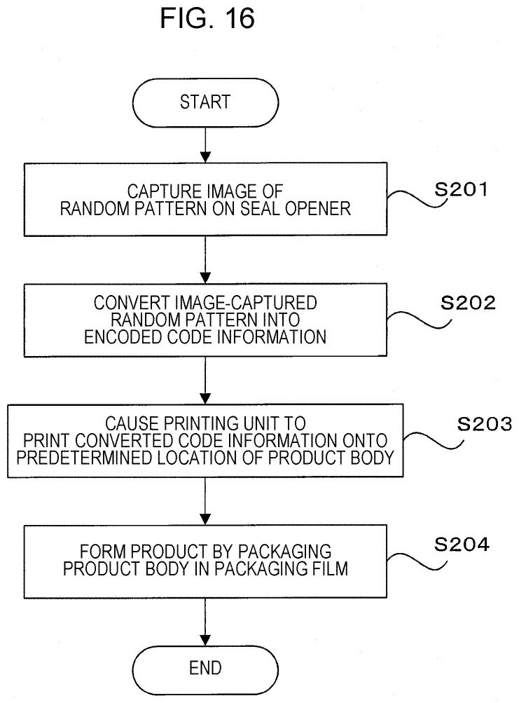

The operation of the product manufacturing apparatus shown in FIG. 15 will now be described with reference to a flowchart in FIG. 16.

In step S201, the controller 76 controls the camera 72 so as to capture an image of a specific region of the seal opener 43, thereby acquiring a random pattern in one region on the surface of the seal opener 43 provided in the packaging film 41. In step S202, the acquired random pattern is converted into encoded code information by the encoding unit 77. In step S203, the controller 76 causes the printing unit 78 to print the code information converted by the encoding unit 77 as the two-dimensional code 53 onto a predetermined location of the product body 142.

In step S204, the controller 76 controls the packaging device 73 so that the product body 142 is packaged in the packaging film 41, thereby forming the product 140.

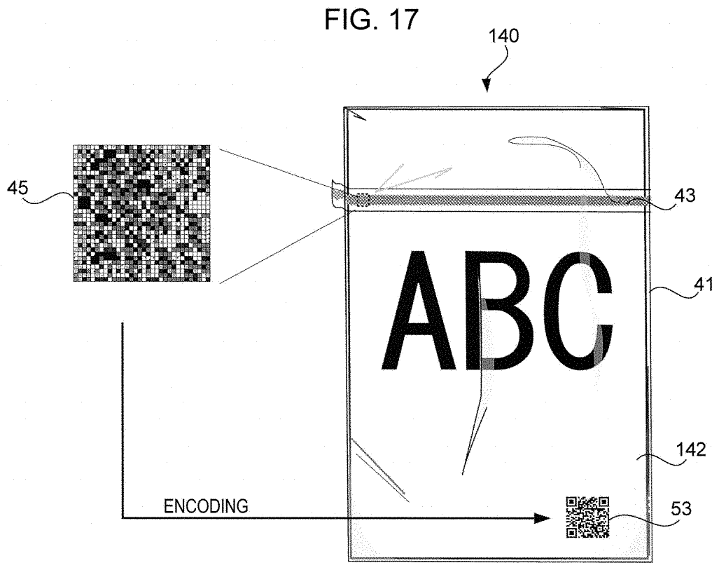

As shown in FIG. 17, the product 140 manufactured in this manner is configured such that a random pattern 45 acquired from a predetermined region of the seal opener 43 is encoded and is printed as the two-dimensional code 53 on the surface of the product body 142.

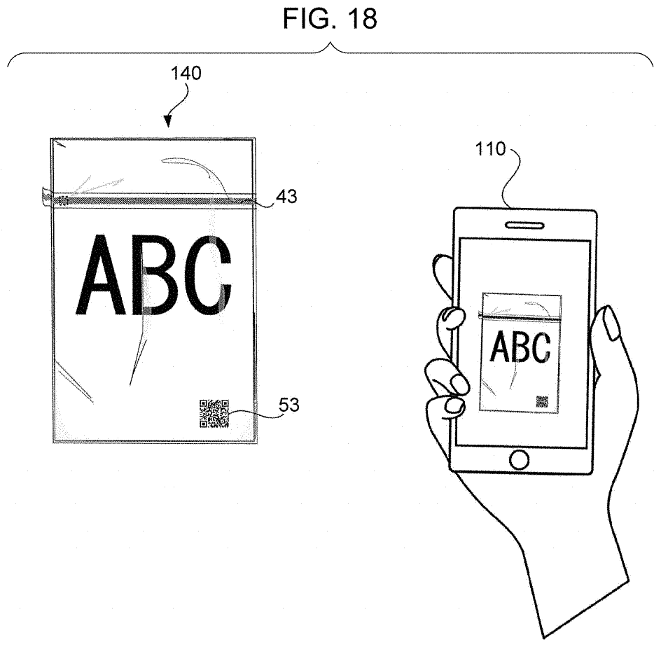

Next, a determination apparatus for checking whether or not the product 140 has been opened will be described with reference to FIG. 18.

In this exemplary embodiment, the random pattern and the identification information do not have to be stored in advance in association with each other. Therefore, components such as the random-pattern storage units 23 and 75 according to the first exemplary embodiment described above are not necessary. As a result, a portable terminal apparatus 110 shown in FIG. 18 does not have to make a determination request by communicating with a server, and is capable of independently determining whether the product 140 has not been opened after being shipped from the factory or has been repackaged after being opened once.

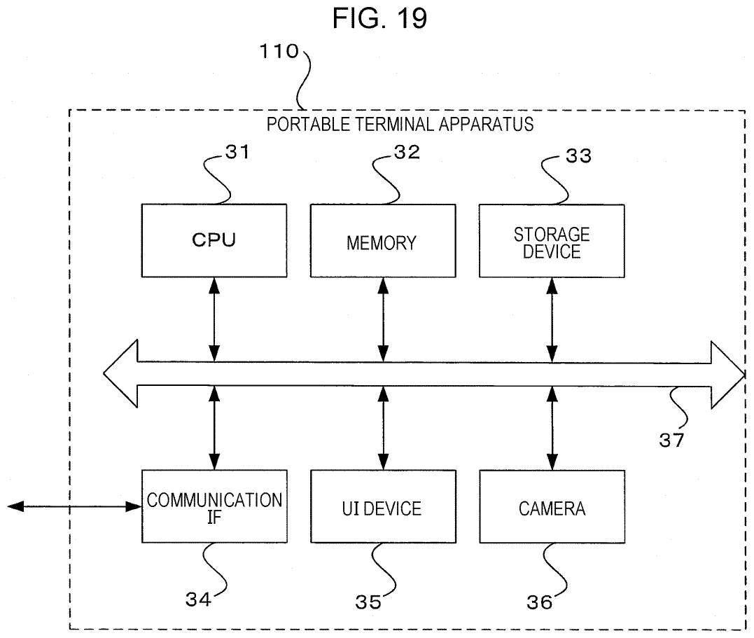

Next, a hardware configuration of the portable terminal apparatus 110 functioning as such a determination apparatus will be described with reference to FIG. 19.

As shown in FIG. 19, the portable terminal apparatus 110 includes a CPU 31, a memory 32, a storage device 33, such as a flash memory, a communication IF 34 that transmits and receives data to and from an external device via a network, a UI device 35 that includes a touchscreen or a liquid crystal display and a keyboard, and a camera 36 for capturing an image. These components are connected to one another via a control bus 37.

The CPU 31 executes a predetermined process based on a control program stored in the memory 32 or the storage device 33, so as to control the operation of the portable terminal apparatus 110. In this exemplary embodiment, the CPU 31 reads and executes the control program stored in the memory 32 or the storage device 33. Alternatively, the program may be stored in a storage medium, such as a CD-ROM, and may be provided to the CPU 31.

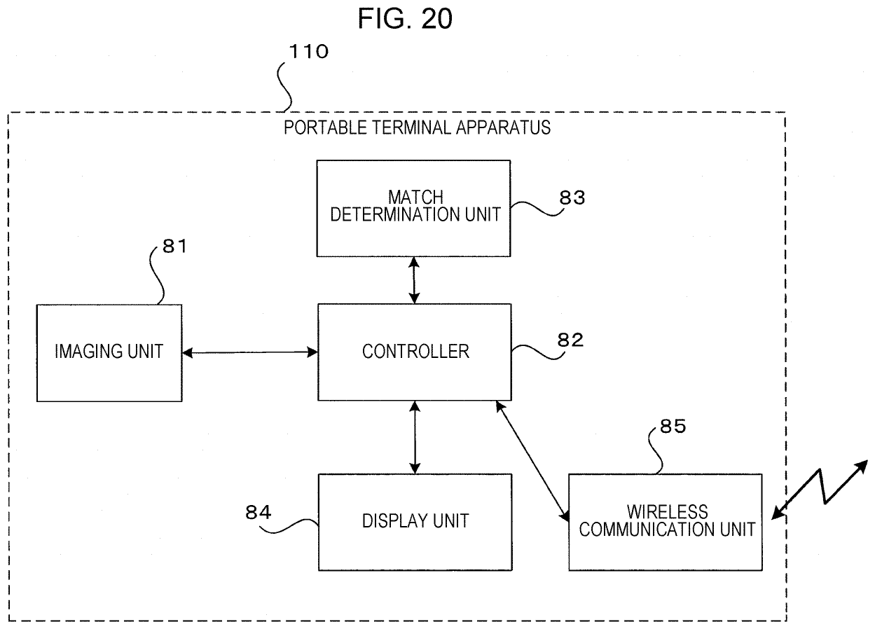

FIG. 20 is a block diagram illustrating a functional configuration of the portable terminal apparatus 110 realized by executing the aforementioned control program.

As shown in FIG. 20, the portable terminal apparatus 110 according to this exemplary embodiment includes an imaging unit 81, a controller 82, a match determination unit 83, a display unit 84, and a wireless communication unit 85.

The imaging unit 81 acquires a random pattern in one region on the surface of the seal opener 43 by capturing an image of the seal opener 43 of the packaging film 41 in the product 140 subject to the determination process. The imaging unit 81 also acquires code information of the two-dimensional code 53 from the product body 142 constituting the product 140 subject to the determination process.

The match determination unit 83 determines whether or not the random pattern on the surface of the seal opener 43 and a random pattern obtained by decoding the code information of the two-dimensional code 53 match.

Based on the determination result obtained by the match determination unit 83, if the encoded random pattern in the acquired code information of the two-dimensional code 53 and the acquired random pattern of the seal opener 43 match, the controller 82 notifies the user, via the display unit 84, that the product 140 subject to the determination process has not been opened.

In this exemplary embodiment, since the packaging film 41 is formed of a transparent material, the imaging unit 81 is capable of acquiring the two-dimensional code 53 printed on the surface of the product body 142 from the product body 142 through the packaging film 41.

### Modifications

The above exemplary embodiments each relate to a case where it is checked whether a product in which a product body thereof is packaged in a packaging film serving as a packaging member has been opened. However, the present disclosure is not limited to the above exemplary embodiments. The present disclosure is similarly applicable to a case where it is checked whether or not a combination of a first member and a second member constituting a product has been changed after shipment of the product.

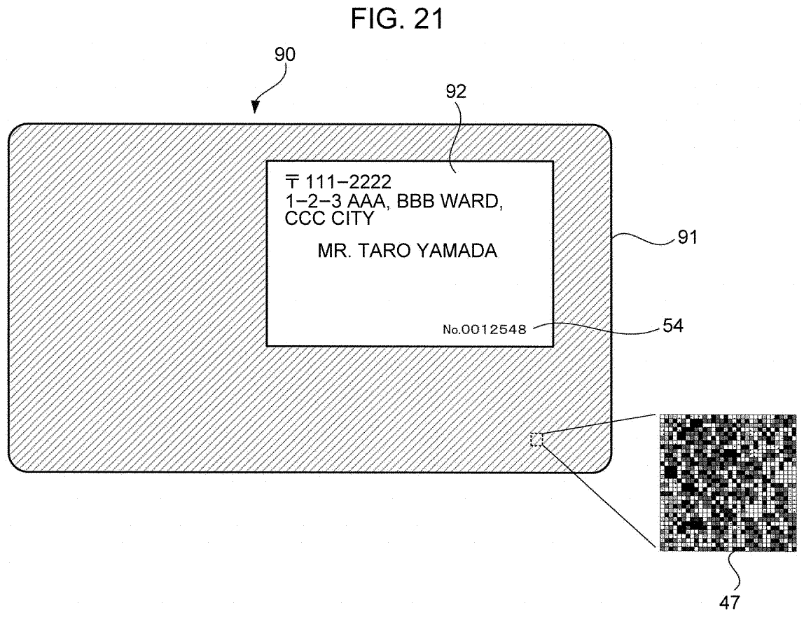

For example, as shown in FIG. 21, with regard to a sealed document 90 constituted of a document 92 sealed within an envelope 91, the present disclosure may be applied to a case where the envelope 91 is partially formed of a transparent or semitransparent film such that the document 92 is partially visually recognizable. In such a case, identification information 54 printed on the document 92 and a random pattern 47 acquired from one region on the surface of the envelope 91 are stored in association with each other, so that it may be possible to check whether the sealed document 90 has been opened by someone after being dispatched.

Furthermore, the present disclosure may also be applied to a case where it is determined whether or not a food product, such as a plastic bottle sealed with a lid that is to be partially broken once it is opened, has been opened after shipment.

According to the present disclosure, a random pattern on a component attached to a product is acquired and is stored in association with a serial number of the product, so that it may be determined whether or not the component has been replaced with another one after shipment of the product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A product manufacturing method comprising:
acquiring a random pattern in one region on a surface of a first member by capturing an image of the first member;
acquiring identification information, based on which a second member is individually identifiable, from the second member, the second member being combined with the first member to constitute a product;
storing the acquired random pattern and the acquired identification information in association with each other; and
forming the product by combining the first member and the second member.

2. The product manufacturing method according to claim 1,
wherein the identification information based on which the second member is individually identifiable is a random pattern on a surface of the second member.

3. The product manufacturing method according to claim 1,
wherein the identification information based on which the second member is individually identifiable is serial number information indicated on the second member.

4. A product manufacturing method comprising:
acquiring a random pattern in one region on a surface of a first member by capturing an image of the first member;
generating code information by encoding the acquired random pattern; and
printing the generated code information onto a surface of a second member, the second member being combined with the first member to constitute a product.

5. The product manufacturing method according to claim 4, further comprising:
forming the product by combining the first member and the second member after the code information is printed on the second member.

6. The product manufacturing method according to claim 1,
wherein the first member is a packaging member in which the second member is packaged.

7. The product manufacturing method according to claim 2,
wherein the first member is a packaging member in which the second member is packaged.

8. The product manufacturing method according to claim 3,
wherein the first member is a packaging member in which the second member is packaged.

9. The product manufacturing method according to claim 4,
wherein the first member is a packaging member in which the second member is packaged.

10. The product manufacturing method according to claim 5,
wherein the first member is a packaging member in which the second member is packaged.

11. The product manufacturing method according to claim 6,
wherein the packaging member is at least partially formed of a transparent or semitransparent material, and
wherein the identification information based on which the second member is individually identifiable or code information printed on a surface of the second member is readable from the second member in a state where the second member is packaged in the packaging member.

12. A product comprising:
a first member having a random pattern on a surface of the first member; and
a second member having code information printed on a surface of the second member, the code information being an encoded random pattern in one region on the surface of the first member obtained by capturing an image of the first member,
wherein the first member and the second member are combined with each other.

13. A non-transitory computer readable medium storing a program causing a computer to execute a process, the process comprising:
storing a random pattern acquired from a first member in a product and identification information acquired from a second member in the product into a storage unit in association with each other, the product being constituted of a combination of the first member and the second member;
acquiring the random pattern in one region on a surface of the first member by capturing an image of the first member in the product subject to a determination process;
acquiring the identification information, based on which the second member is individually identifiable, from the second member constituting the product subject to the determination process; and
reading, from the storage unit, the random pattern stored in association with the acquired identification information and providing a notification indicating that the combination of the first member and the second member is not changed in the product subject to the determination process if the read random pattern and the acquired random pattern match.

14. A non-transitory computer readable medium storing a program causing a computer to execute a process, the process comprising:
acquiring a random pattern in one region on a surface of a first member by capturing an image of the first member in a product subject to a determination process, the product being constituted of a combination of the first member and a second member;
acquiring code information from the second member constituting the product subject to the determination process; and
providing a notification indicating that the combination of the first member and the second member is not changed in the product subject to the determination process if an encoded random pattern in the acquired code information and the acquired random pattern match.
